(19) United States
(12) Patent Application Publication
(10) Pub. No.: US 2016/0102560 A1
(43) Pub. Date: Apr. 14, 2016

(54) A METHOD FOR TREATING A COMPONENT TO PREVENT EROSION OF SUCH COMPONENT

(71) Applicant: NUOVO PIGNONE SRL, Florence (IT)

(72) Inventors: Massimo GIANNOZZI, Florence (IT); Michelangelo BELLACI, Florence (IT); Lorenzo COSI, Florence (IT); Iacopo GIOVANNETTI, Florence (IT)

(21) Appl. No.: 14/890,958

(22) PCT Filed: May 16, 2014
(86) PCT No.: PCT/EP2014/060128

§ 371 Date: Nov. 13, 2015

(30) Foreign Application Priority Data
May 17, 2013 (IT) CO2013A000018

(51) Int. Cl. F01D 5/14; B32B 15/01; C23C 24/04; B05D 1/02; B05B 7/16

(52) U.S. Cl. CPC F01D 5/147; B05D 1/02; B05B 7/16; C23C 24/04; B32B 15/01

(57) ABSTRACT

A high velocity spray method for treating the surface of a component, the method comprises the steps of heating a first portion of an inert gas up to a spray temperature comprised between 550° C. and 800° C.; preparing a powder material having a composition including Co at a mass percentage comprised between 15% and 70%; preparing a mixture between the powder material and a second portion of inert gas; mixing the first portion of inert gas and the mixture of gas and powder in a spray gun in order to create a spray jet; directing said spray jet towards the surface to be treated in order to deposit a coating of the material including Co.

### TECHNICAL FIELD

Embodiments of the present invention relate to method for treating the surface of a component subject to erosion by liquids or due to cavitation phenomena. Embodiments of the present invention also relate to a component including a surface treated with such method and to an apparatus for performing such method.

### BACKGROUND

It is well known to apply a wear alloy coating to the surface of a substrate material in order to improve its resistance to erosion. For components of rotating machines like steam turbines, centrifugal and axial compressors, pumps and other rotating machines, it is particularly important to exhibit a sufficient degree of resistance to liquid droplet erosion or erosion deriving from cavitation phenomena. For example, in steam turbines, liquid droplet erosion typically occurs along the leading edge of blades.

Known methods for applying erosion resistant coating to such surfaces includes: surface hardening, laser cladding, brazing, welding.

The above technologies typically involve heat input to the substrate material, which typically determines the following inconveniencies: presence of a heat affected zone which could make the component not compliant with NACE standards, distortion of the coated component, need for post heating treatments, cracks, iron dilution in the coating, inhomogeneous microstructure.

In addition, the above technologies cannot be used to deposit a coating including non-weldable materials.

It would be therefore desirable to provide an improved method for treating a surface of a component which could avoid the inconveniences above.

### SUMMARY OF THE INVENTION

According to a first embodiment, the present invention accomplishes such an object by providing a method for treating the surface of a component, the method comprising the steps of: heating a first portion of an inert gas up to a spray temperature comprised between 550° C. and 800° C.; preparing a powder material having a composition including Co at a mass percentage comprised between 15% and 70%; preparing a mixture between the powder material and a second portion of inert gas; mixing the first portion of inert gas and the mixture in a cold gun in order to create a spray jet; directing the spray jet towards the surface in order to deposit a coating of the material.

The solution of the present invention allows to deposit a coating on a surface of a substrate material in order to improve its resistance to erosion. In the coating thus created, the following mechanical properties can be achieved: Hardness (Vickers): 400<HV<1000, Porosity: <2%.

In a second embodiment, the above advantages are achieved by means of an apparatus including: a first heater for pre-heating a first portion of inert gas up to a pre-heating temperature comprised between 400° C. and 500° C.; a spray gun including a final heater for heating the first portion of inert gas up to a spray temperature comprised between 550° C. and 800° C. and a supersonic nozzle for creating a spray jet including the inert gas and a powder material having a composition including Co at a mass percentage comprised between 15% and 70%; a powder feeder preparing a mixture between the powder material and a second portion of inert gas; at least a first duct for connecting the first heater to the final heater; at least a second duct for connecting the powder feeder to the supersonic nozzle.

### BRIEF DESCRIPTION OF THE DRAWINGS

Other object feature and advantages of the present invention will become evident from the following description of the embodiments of the invention taken in conjunction with the following drawings, wherein:

FIGS. 1A and 1B show two different views of a component according to the prior art, subject to liquid droplet erosion;

FIG. 2 is a schematic diagram showing an apparatus for performing the method according to an embodiment of the present invention.

FIG. 3 is a schematic view of a component of the apparatus in FIG. 2.

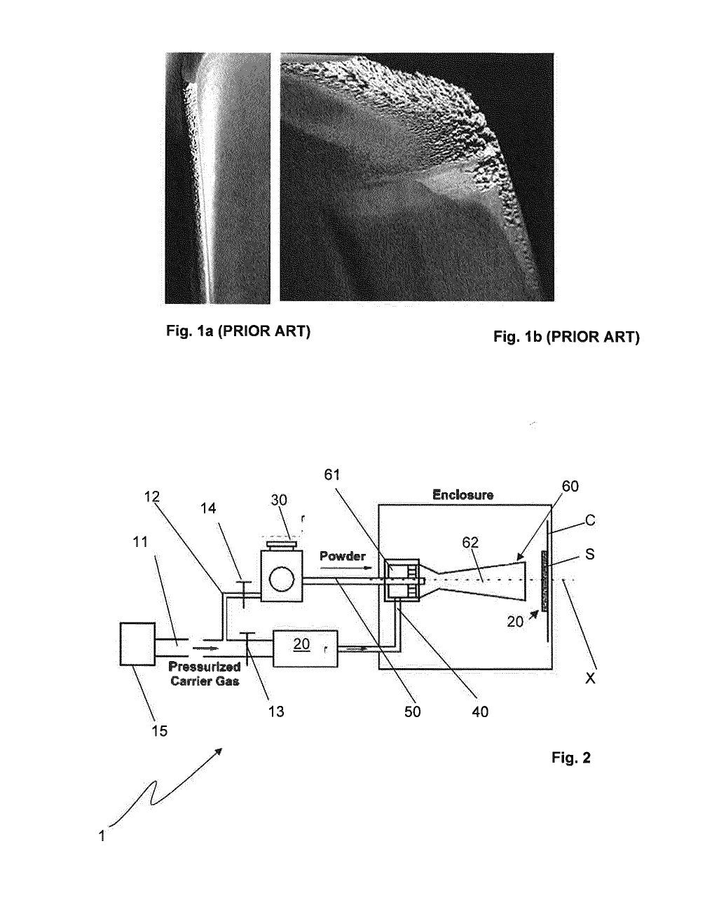

### DETAILED DESCRIPTION

Embodiments of the present invention provides a method for treating a surface of a component in order to improve wear resistance, in particular to liquid droplet erosion and to erosion deriving from cavitation phenomena. Particularly, albeit not exclusively, an embodiment of the present invention is applied to components of rotating machines, e.g. steam turbines, centrifugal and axial compressors and pumps.

The method utilizes a high velocity spray technique to apply a coating of a ductile material on a surface of a component.

With reference to FIG. 2, an apparatus for performing a method according to an embodiment of the present invention is indicated as a whole with the reference number 1. Apparatus 1 comprises an upstream duct 10 for connecting a gas source 15 of pressurized carrier gas to a first gas heater 20 and a powder feeder 30, both of conventional and known type and therefore not described in detail. The carrier gas is nitrogen (N2) or Helium (He2) or other convenient inert gas. The carrier gas flows in the apparatus at a pressure comprised between 20 bar and 50 bar. The gas flow rate of the carrier gas is comprised between 2 m3/hour and 6 m3/hour.

The upstream duct 10 comprises a first main branch 11 connecting the gas source 15 to the first gas heater 20 and a secondary branch 12 departing from the first main branch 11 for connecting the gas source 15 to the powder feeder 30. Downstream the intersection the two branches 11, 12 of the upstream duct 10, the main branch 11 and secondary branch 12 respectively comprises a first and a second valve 13, 14 for regulation or stopping the flow of the carrier gas in the main branch 11 and secondary branch 12, respectively.

In the first gas heater 20 a first portion of the carrier gas is pre-heated up to a pre-heating temperature T1 comprised between 400° C. and 500° C. Downstream the first gas heater 20 the pre-heated carrier gas flows in a first downstream duct 40 which connects the first gas heater 20 to a spray gun 60. Along the first downstream duct 40 the temperature of carrier gas decreases down to a release temperature T2, in the section immediately upstream the spray gun 60. Release temperature T2 is lower than the pre-heating temperature T1 and comprised between 350° C. and 450° C.

In the powder feeder 30 a second portion of the carrier gas flowing from the second branch 12 of the upstream duct 10 is mixed with a spray powder of a ductile material having a composition including a mass percentage of Co comprised between 15% and 70%. For example, ductile materials which can be used in the spray powder according to embodiments of the present invention include: stellite® 6, stellite® 12, stellite® 21, materials defined in U.S. Pat. No. 6,986,951.

Downstream of the powder feeder 30 the mixture of carrier gas and spray powder flows in a second downstream duct 50 which connects the powder feeder 30 to the spray gun 60.

The spray gun 60 extends along a longitudinal axis X and comprises a final heater 60 and a supersonic nozzle 61, which is connected to the final heater 60, downstream thereof. In operation the spray gun 60 is housed within a spray enclosure 70 together with the surface of the component C on which a coating S of spray material is to be sprayed. The surface to be sprayed is positioned in the enclosure 70 perpendicularly to the longitudinal axis X.

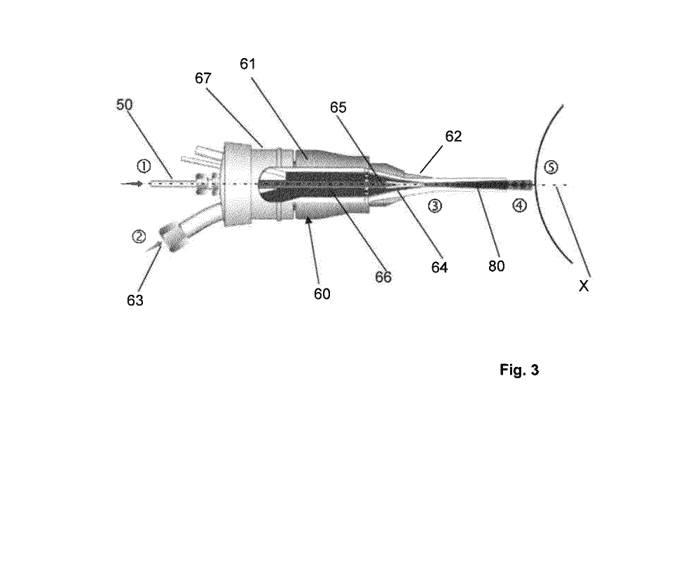

With reference to FIG. 3, the final heater 60 comprises an outer housing 67 and a heating chamber 66, which extends along the longitudinal axis X from an inlet section 63 which is connected to the first downstream duct 40 to an outlet section 64, immediately upstream to the supersonic nozzle 61. The carrier gas from the first downstream duct 40 flows through the heating chamber 66 from the inlet section 63 to the outlet section 64. In the heating chamber 66 the carrier gas is heated again up to a spray temperature T3 higher than the release temperature T2 and comprised between 550° C. and 800° C. The final downstream portion of the second downstream duct 50 is coaxial with the longitudinal axis X and passes through the heating chamber 66 up to a final section 65, immediately upstream the supersonic nozzle 61. The outlet section 64 of the heating chamber 66 encircles annularly the final section 65 of second downstream duct 50. When exiting the final heater 60, i.e., respectively, the heating chamber 66 and the last downstream portion of the second downstream duct 50, the re-heated first portion of carrier gas and the mixture of powder and second portion of carrier gas mix together to form a spray jet 80 and enter the supersonic nozzle 61.

In the supersonic nozzle 61 the spray jet 80 expands and the powder particle reaches a velocity v. Through the supersonic nozzle 61 the spray jet 80 is directed towards a surface on the component C in order to create the coating S. In an embodiment, values of velocity v are: greater than 300 m/s, when the carrier gas is Nitrogen, greater than 1000 m/s, when the carrier gas is Helium, Efficiency of deposit is greater than 80%. In the deposited coating S, the following mechanical properties can be achieved: Hardness (Vickers): 400<HV<1000, Porosity: <2%.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A high velocity spray method for treating the surface of a component, the method comprising the steps of:
heating a first portion of an inert gas up to a spray temperature comprised between 550° C. and 800° C.;
preparing a powder material having a composition including Co at a mass percentage comprised between 15% and 70%;
preparing a mixture between said powder material and a second portion of inert gas;
mixing said first portion of inert gas and said mixture in a spray gun in order to create a spray jet; and,
directing said spray jet towards said surface in order to deposit a coating of said material.

2. The method according to claim 1, wherein said step of heating is preceded by a pre-heating step in which said first portion of carrier gas is pre-heated up to a pre-heating temperature lower than said spray temperature and comprised between 400° C. and 500° C.

3. The method according to claim 1, wherein said inert gas is nitrogen and/or helium.

4. The method according to claim 1, wherein the pressure of said carrier gas upstream said spray jet is comprised between 20 bar and 50 bar.

5. An apparatus for spraying the surface of a component, said apparatus including:
a first heater for pre-heating a first portion of inert gas up to a pre-heating temperature comprised between 400° C. and 500° C.;
a spray gun including a final heater for heating said first portion of inert gas up to a spray temperature comprised between 550° C. and 800° C. and a supersonic nozzle for creating a spray jet including said inert gas and a powder material having a composition including Co at a mass percentage comprised between 15% and 70%;
a powder feeder preparing a mixture between said powder material and a second portion of inert gas;
at least a first duct for connecting said first heater to said final heater;
at least a second duct for connecting said powder feeder to said supersonic nozzle.

6. A component including a surface treated according to the method in claim 1.

7. The component according to claim 6, wherein said component is a steam turbine blade.
